(19) United States
(12) Patent Application Publication
(10) Pub. No.: US 2024/0367999 A1
(43) Pub. Date: Nov. 7, 2024

(54) SUPERCRITICAL WATER OXIDATION FEED STREAMS AND METHODS OF PRODUCTION

(71) Applicant: AxNano LLC, Greensboro, NC (US)

(72) Inventors: Alexis Wells Carpenter, Chapel Hill, NC (US); David Lawrence Bollinger, San Francisco, CA (US)

(73) Assignee: AxNano LLC, Greensboro, NC (US)

(21) Appl. No.: 18/653,142

(22) Filed: May 2, 2024

Related U.S. Application Data
(60) Provisional application No. 63/499,682, filed on May 2, 2023.

(51) Int. Cl. C02F 1/00; C02F 11/08; C02F 101/32

(52) U.S. Cl. CPC C02F 1/008; C02F 11/086; C02F 2101/32; C02F 2209/05; C02F 2209/09; C02F 2209/10

(57) ABSTRACT

Methods of preparing a feed stream for supercritical water oxidation from at least two waste streams are described herein. The method generally involves monitoring contaminant concentration, total dissolved solids concentration, viscosity, salt concentration, and calorific value of each waste stream and combining those waste streams, and optionally a non-waste additive, into a single feed stream to achieve a specific contaminant concentration, total dissolved solids concentration, viscosity, salt concentration, and calorific value prior to supercritical water oxidation. The disclosure also describes systems capable of monitoring contaminant concentration, total dissolved solids, viscosity (solids concentration and particle size), salt concentration, and calorific value in at least two waste streams, combining those waste streams into a new feed stream, and monitoring that feed stream to ensure compatibility with continuous feed into a supercritical water oxidation reactor.

### FIELD OF THE INVENTION

The present invention relates to supercritical water oxidation reactor feed streams for environmental contaminant remediation and methods of making and using the same.

### BACKGROUND OF THE INVENTION

Supercritical water oxidation (SCWO) is a process used in waste treatment for the highly efficient destruction of organic compounds. The SCWO process involves heating and pressurizing water to a supercritical state, typically at temperatures between 60° and 650° C. and pressures of at least 22 megapascals (MPa). In the supercritical state, water is fully miscible with both air and organic compounds, creating ideal conditions for complete oxidation of organic matter. Organic compounds dissolved in supercritical water will react with oxygen in air to form carbon dioxide and water, leading to full mineralization of organic contaminants in the feed stream. Due to the high reactivity of organic compounds in the supercritical environment, SCWO is a promising technology for the treatment of recalcitrant contaminants such as per- and poly-fluorinated alkylated substances (PFAS), dioxanes, and halogenated organic compounds.

Due to the relatively high energy costs of maintaining water in the supercritical state, SCWO reactors typically recycle energy produced from the combustion and oxidation of organic matter to provide the temperature requirements for supercritical operation. As a result, SCWO processes often benefit from feed streams with high organic content such as sludges. High energy additives such as diesel fuel and other organic input streams may also be added to ensure that the feed stream for the SCWO process has a sufficiently high calorific value.

In contrast to organic compounds, inorganic compounds such as salts are typically much less soluble in supercritical water. This insolubility may cause fouling of the SCWO reactor components, corrosion, and clogging of tubing and pumps. Solutions for this problem often involve incorporation of new corrosion-resistant materials into the SCWO reactor, or novel SCWO configurations that necessitate taking the SCWO reactor offline for reconfiguration and customized tooling.

Hence, an improved method for preparing feed streams to achieve a desired range of values for parameters such as contaminant concentration, salt content, viscosity, total dissolved solids and calorific value may offer a more efficient and versatile method for treating waste by SCWO. Such a process would eliminate the need to take a SCWO reactor offline for reconfiguration, and instead enable continuous feed by control of the feed stream.

### SUMMARY OF THE INVENTION

The present disclosure provides a multi-step process for preparing a supercritical water oxidation feed stream from multiple waste streams. This process involves monitoring parameters critical to SCWO reactor compatibility in a waste stream, such as contaminant concentration, total dissolved solids, viscosity (solids concentration and particle size), salt concentration, and calorific value. Once these parameters are determined, the input waste streams are combined into a new feed stream, such that the feed stream achieves a desired range of values for these critical parameters. The parameters of contaminant concentration, total dissolved solids, viscosity (solids concentration and particle size), salt concentration, and calorific value are also monitored in the resulting feed stream, and if necessary, additional volumes of waste stream inputs or optionally non-waste stream additives may be added to the feed stream for further tuning of those parameters.

In some embodiments, contaminant concentration may be determined by a variety of methods, including but not limited to spectrophotometry, liquid or gas chromatography, mass spectrometry, and data from waste manifests. In some embodiments, multiple techniques may be employed to determine contaminant concentrations.

In certain embodiments, total suspended solids may be monitored using a turbidity meter and reduced as needed via filtration to improve SCWO reactor compatibility. In certain embodiments, total dissolved solids may be determined by gravimetric analysis, whereby a known volume of waste is centrifuged, and the resulting solids are de-watered and weighed. In certain embodiments, viscosity may be determined by a viscometer. In certain embodiments, the calorific value of the feed may be determined by calorimetry.

The disclosed process, in some embodiments, can include additional method steps before, simultaneously with, or after any of the steps referenced above. For example, in certain embodiments, additional parameters may be monitored such as thermal expansion coefficients of the waste streams or waste stream constituents, vapor pressure of the waste stream, the identity of inorganics present (for instance, nitrogen-or-sulfur containing compounds), and particle size distribution.

In certain embodiments, the monitoring of parameters and combination of waste streams are done substantially simultaneously. In certain embodiments, the monitoring of parameters and combination of waste streams are done sequentially.

In certain embodiments, additional non-waste additives may be added to the feed stream to achieve desired parameters for contaminant concentration, total dissolved solids, viscosity (solids concentration and particle size), salt concentration, and calorific value. These non-waste additives include but are not limited to diesel fuel, hydrocarbons, polymers, lubricating oils, brines, and slurries.

In some embodiments, pre-treatment of individual waste streams may be desired to remove large particles, salts, or adjust pH. In certain embodiments, filtration may be desired to remove particulates, especially particulates having a largest dimension of greater than approximately 1 millimeter. In other embodiments, inorganic salts may be removed by precipitation or chelation. In certain embodiments, pH values may be adjusted through the addition of acids or bases, including but not limited to hydrochloric acid and sodium hydroxide. In certain embodiments, organic acids or bases may be added to adjust the waste stream pH without introducing inorganic salts into the waste stream. In certain embodiments, addition of organic acids or bases may have the added benefit of adjusting the calorific value of the waste stream.

The process for preparing a feed stream compatible from at least two waste streams compatible with continuous operation of a SCWO reactor can be used for a variety of waste products, including medical waste, industrial waste, agricultural waste, munitions waste, and environmental waste. The method of preparing a single feed stream may be used for treatment of halogenated wastes, PFAS, organic contaminants, dioxanes, proteins, viral particles, and other genetic material.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended by included within the scope of the appended claims. Although specific terms are employed herein, they are used in a generic and descriptive sense only and not for purposes of limitation.

What is claimed is:

1. A method for preparing a feed stream for supercritical water oxidation, comprising: combining at least two waste streams and optionally one non-waste feedstock to form a single feed stream; monitoring the contaminant concentration of each of the at least two waste streams and the feed stream; monitoring the total dissolved solids concentration of each of the at least two waste streams and the feed stream; monitoring the viscosity of the feed stream; monitoring particle sizes of solids, monitoring the salt concentration of each of the at least two waste streams and the feed stream; and monitoring the calorific value of each of the at least two waste streams and the feed stream;
and adjusting the ratio of each of the at least two waste streams and optionally one non-waste feedstock added to the feed stream to achieve a contaminant concentration between approximately 1 part per trillion (ppt) to approximately 1000 parts per million (ppm), a total dissolved solids concentration between approximately 100 ppm to approximately 2000 ppm, a particle size of less than approximately 1 mm, a slurry solids concentration less than approximately 50% by weight, a salt concentration less than approximately 37% by weight, and a calorific value of at least approximately 2,200 BTU/lb.

2. The method of claim 1, wherein the non-waste feedstocks are diesel fuel, water or both diesel fuel and water.

3. The method of claim 1, wherein the at least two waste streams are selected from the group consisting of industrial waste, municipal waste, medical waste, agricultural waste, and food waste.

4. The method of claim 1, wherein at least one of the at least two waste streams contains a perfluoroalkyl substance or polyfluoroalkyl substance, or a perfluoroalkyl substance and polyfluoroalkyl substance, at a total concentration of at least approximately 10 ppt.

5. The method of claim 1, wherein the supercritical water oxidation reactor operates at a temperature and pressure in the range of 400° C. to 650° C. and 22 MPa to 30 MPa, respectively.

6. The method of claim 1, wherein the contaminant concentration is monitored using a spectroscopic technique, chromatographic technique, spectrometric technique, or a combination of these techniques.

7. The method of claim 5, wherein the total dissolved solids concentration is monitored using gravimetric analysis, the viscosity is monitored using a viscometer, the salt concentration is monitored using a conductivity meter, and the calorific value is monitored using a calorimeter.

8. The method of claim 1, wherein the waste streams are pre-treated prior to addition to the feed stream.

9. The method of claim 7, wherein the pre-treatment comprises one or more steps selected from the group consisting of filtration, pH adjustment, and addition of chemical additives.

10. A device for preparing a feed stream for supercritical water oxidation, comprising (a) a series of monitoring devices for each of at least two waste streams, those monitoring devices recording contaminant concentration, total dissolved solids, particle sizes, solid concentrations, salt concentration, viscosity, and calorific value of each waste stream; (b) a pump for each of the at least two waste streams in series with a holding tank; (c) a metering device for discharging a desired quantity of waste from the waste stream to the holding tank; (d) a series of monitoring devices for the contents of the holding tank, those monitoring devices recording contaminant concentration, total dissolved solids, particle size, solid concentrations, salt concentration, viscosity, and calorific value of each waste stream; (e) a computer in communication with the pump for each of the at least two waste streams capable of adjusting the ratio of the at least two waste streams added to the holding tank.
